(19) United States
(12) Patent Application Publication
(10) Pub. No.: US 2017/0300589 A1
(43) Pub. Date: Oct. 19, 2017

(54) VIRTUAL OFFICE

(71) Applicant: Maria Francisca JONES, Middlesex (GB)

(72) Inventors: Maria Francisca JONES, Middlesex (GB); Alexander JONES, Middlesex (GB)

(21) Appl. No.: 15/642,229

(22) Filed: Jul. 5, 2017

Related U.S. Application Data
(63) Continuation-in-part of application No. 15/395,321, filed on Dec. 30, 2016.

(30) Foreign Application Priority Data
Dec. 31, 2015 (GB) 1523166.5

(51) Int. Cl. G06F 17/30; G06F 3/0481; G06F 17/22

(52) U.S. Cl. CPC G06F 17/30873; G06F 3/04817; G06F 17/2235; G06F 3/0481; G06F 17/30; G06F 17/22

(57) ABSTRACT

A method of providing a virtual office, the method comprising generating an output for display of a virtual office including a plurality of images of items of office equipment arranged in the virtual office, each item of office equipment having stored image data for use in the generation of the image in the virtual office and code to perform an associated office function; receiving a user input to select an image of an item of office equipment and to identify an operation to be performed by the office equipment; performing the identified operation; and modifying the generated output for display to display an image of the selected item of office equipment performing the selected function.

### RELATED APPLICATIONS

This application is a continuation in part of U.S. patent application Ser. No. 15/395,321 filed on Dec. 30, 2016 and entitled “DIRECT INTEGRATION SYSTEM”, which claims priority to Great Britain patent application GB1523166.5 filed Dec. 31, 2015, the contents of which are hereby incorporated by reference in their entirety.

### FIELD OF THE INVENTION

The present disclosure relates to methods and systems for providing a virtual office.

### BACKGROUND INFORMATION

Office workers are required to use many different programs on computers and items of office equipment to perform their office functions. Office workers often require significant training on how to use items of office equipment and the array of programs that they are required to use.

There is thus a need to simplify the way office workers can perform their office functions.

### SUMMARY OF THE INVENTION

One aspect provides a method of providing a virtual office, the method comprising generating an output for display of a virtual office including a plurality of images of items of office equipment arranged in the virtual office, each item of office equipment having stored image data for use in the generation of the image in the virtual office and code to perform an associated office function; receiving a user input to select an image of an item of office equipment and to identify an operation to be performed by the office equipment; performing the identified operation; and modifying the generated output for display to display an image of the selected item of office equipment performing the selected function.

Another aspect of the invention provides a system to provide a virtual office comprising at least one processor; and a memory storing instructions, which instructions being executable by the at least one processor to generate an output for display of a virtual office including a plurality of images of items of office equipment arranged in the virtual office, each item of office equipment having stored image data for use in the generation of the image in the virtual office and code to perform an associated office function; receive a user input to select an image of an item of office equipment and to identify an operation to be performed by the office equipment; perform the identified operation; and modify the generated output for display to display an image of the selected item of office equipment performing the selected function.

Another aspect of the invention provides a carrier medium or a storage medium carrying code executable by a processor to carry out the deferred search method.

### BRIEF DESCRIPTION OF THE DRAWINGS

FIG. 1 is a schematic diagram illustrating a generalized system according to one embodiment;

FIG. 2 is a flow diagram of a method of providing a virtual office using the system of FIG. 1 according to one embodiment;

FIG. 3 is a schematic diagram illustrating an office system according to one embodiment;

FIG. 4 is a schematic diagram illustrating a networked system according to one embodiment;

FIG. 5 is a schematic diagram illustrating a display of a virtual office output from the system according to one embodiment;

FIGS. 6A and 6B are schematic diagrams illustrating a display of a virtual office output from the system during file selection according to one embodiment;

FIGS. 7A and 7B are schematic diagrams illustrating a display of a virtual office output from the system during document selection according to one embodiment;

FIGS. 8A and 8B are schematic diagrams illustrating a display of a virtual office output from the system during page turning of a document according to one embodiment;

FIGS. 9A and 9B are schematic diagrams illustrating a display of a virtual office output from the system during writing of a document according to one embodiment;

FIG. 10 is a diagram illustrating a display sequence output from the system during document posting according to one embodiment;

FIGS. 11A and 11B are schematic diagrams illustrating a display of a virtual office output from the system during document writing according to one embodiment;

FIGS. 12A and 12B are schematic diagrams illustrating a display of a virtual office output from the system during mail reading according to one embodiment;

FIGS. 13A and 13B are schematic diagrams illustrating a display of a virtual office output from the system during social network entry according to one embodiment;

FIG. 14 is a schematic diagram illustrating display in a section of a virtual office output from the system during document filing and searching according to one embodiment; and

FIG. 15 is a schematic diagram of a basic computing device for use in one embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

In the following embodiments, data is described as being stored in at least one database. The term database is intended to encompass any data structure (and/or combinations of multiple data structures) for storing and/or organizing data, including, but not limited to, relational databases (e.g., Oracle databases, mySQL databases, etc.), non-relational databases (e.g., NoSQL databases, etc.), in-memory databases, spreadsheets, as comma separated values (CSV) files, eXtendible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores. A “file system” may control how data is stored and/or retrieved (for example, a disk file system like FAT, NTFS, optical discs, etc., a flash file system, a tape file system, a database file system, a transactional file system, a network file system, etc.). For simplicity, the disclosure is described herein with respect to databases. However, the systems and techniques disclosed herein may be implemented with file systems or a combination of databases and file systems.

In the following embodiments, the term data store is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. Another example of a data store is a hosted storage environment that includes a collection of physical data storage devices that may be remotely accessible and may be rapidly provisioned as needed (commonly referred to as “cloud” storage).

The functions or algorithms described herein are implemented in hardware, software or a combination of software and hardware in one embodiment. The software comprises computer executable instructions stored on computer readable carrier media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

A generalized embodiment comprises a method and system for providing a virtual office, in which an output is generated for display of the virtual office including a plurality of images of items of office equipment arranged in the virtual office. Each item of office equipment has stored image data for use in the generation of the image in the virtual office and code to perform an associated office function. A user input is received to select an image of an item of office equipment and to identify an operation to be performed by the office equipment and the identified operation is performed. The generated output for display is modified to display an image of the selected item of office equipment performing the selected function.

The office function may comprise an operation on an electronic document.

The displayed virtual office thus provides a simple and intuitive user interface for an office worker to use to perform office functions. The items of office equipment can comprise any of: paper, writing implements (e.g. pen, pencil, eraser, highlighter etc.), a printer, a scanner, a facsimile machine, a shredder, a filing cabinet, files, a scanner, an in tray, a white board, a pin board, a calculator, and even a computer for implementing applications such as email, a spreadsheet, or budgeting/accounting software. This list is merely illustrative and not exhaustive.

The office functions that can be performed in the virtual office may include, the following operations on a document: filing, searching, shredding, emailing, faxing, printing, scanning, creating, saving opening, closing, editing/modifying, posting, displaying (such as on a shared white board or pin board), etc. The office function can also be the initiating of a telephone call or a video call/conference for example.

In this patent the term ‘document’ is intended to encompass any form of data that is held in a unit for electronic publication or communication in an office environment and it includes photographs and images, text, emails, etc.

In order to provide feedback to the user and to provide an intuitive user interface, the generated output can be modified to display an animation of the image of the selected item performing the selected function. So for example, a shedder function can be illustrated by an image of a shredder shedding a document, a printing function can be illustrated as an image of a printer printing, etc.

The office equipment may comprise paper carrying the electronic document content and the identified operation may comprise turning a page. The generated output is modified in response to display the image of the paper and electronic document content with a page turning.

The office equipment may comprise paper carrying the electronic document content and a writing instrument, such as a pen or pencil. The identified operation may comprise writing on the paper and the generated output is then modified to display the image of the writing appearing on the paper, and the electronic document is modified according to the writing.

The office equipment may include an envelope and the identified operation may comprise writing on the envelope, inserting the paper in the envelope and posting the envelope. This can be termed virtual posting. The generated output is modified in response to display the image of the paper being inserted into the envelope, the image of the writing appearing on the envelope, and the image of the envelope being inserted into a postbox. The identified operation in this case comprises electronically communicating the electronic document in accordance with the writing on the envelope. The writing on the envelope can be input manually by the user or it can be retrieved from a source saved locally or saved remotely, such as saved contact details in an address book. The writing can also be input by cutting and pasting from other displayed text e.g. in another application or window.

The office equipment may comprise files containing documents. The electronic documents may be stored in electronic files associated with images of the files. This can be termed virtual filing. The identified operation can comprise selecting a file, and the generated output can be modified to display an image of the file being selected. The identified operation may comprise opening a file, and the generated output may be modified to display an image of the file being opened. The identified operation may comprise selecting a document in the file, and the generated output may be modified to display an image of the document being opened.

The office equipment may include a telephone or videophone and the associated operation stored for the office function for the telephone may be to a make a voice or video telephone call.

In embodiments the virtual office processing interfaces with office applications providing standard office functions, such as word processing, spreadsheets, presentation applications, email applications, communication applications, messaging applications, image processing applications, drawing applications, document management applications, etc. to provide a more intuitive interface to perform the office functions. The user is able to interact with items of office equipment in a more natural manner in the virtual office environment. The user can also interact with their avatars to control them to operate within the virtual office to interact with the images of the office equipment.

In one embodiment, the code for execution by a processor comprises a virtual office application to generate the output for display of the virtual office, wherein the virtual office application is interfaced to at least one office application for performing the office functions. Thus, standard available office applications, such as a word processing application, a spreadsheet application etc can be used behind the virtual office interface to avoid the need to replace known office applications and provide an easier to use interface without replacing the standard document processing applications of an office.

The user can, in one embodiment, interface with a displayed output and use a pointer device and keyboard to make the user inputs. In alternative embodiments, the user interface can be any form of visual output and any form of input such as keyboard, touch screen, pointer device (such as a mouse, trackball, trackpad, or pen device), audio recognition hardware and/or software to recognize a sounds or speech from a user, gesture recognition input hardware and/or software, etc.

Specific embodiments will now be described with reference to the drawings.

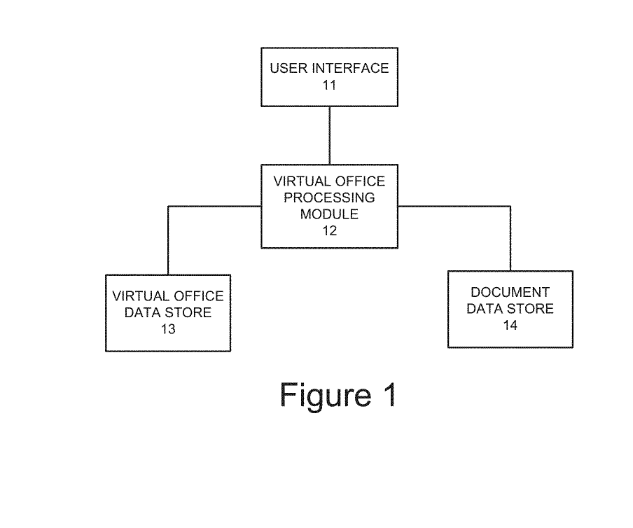

FIG. 1 illustrates a generalized system according to one embodiment.

FIG. 1 illustrates modules implemented in a computing apparatus. The modules comprise logical units of code. However, the functions of the logical units van be performed by any suitable segregation or division of the code into modules.

A user interface 11 is connected to a virtual office processing module 12 to perform the processing to generate the virtual office output for display using the user interface 11. The virtual office processing module 12 accesses virtual office data store 13 that stores all of the required data to generate and render the virtual office environment. For example, the virtual office data store 13 may store image data for the items of office equipment, background office images, etc. A document data store 14 is connected to the virtual office processing module 12 to store the document data for use in the virtual office environment.

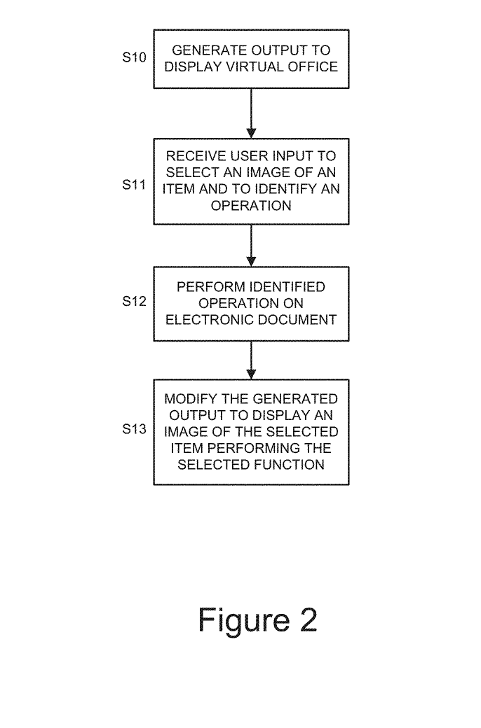

FIG. 2 is a flow diagram of a method of providing a virtual office using the system of FIG. 1 according to one embodiment.

In step S10 an output is generated for display of the virtual office including a plurality of images of items of office equipment arranged in the virtual office. Each item of office equipment has stored image data for use in the generation of the image in the virtual office and code to perform an associated office function. An office function may comprise an operation on an electronic document as broadly defined above. In step S11 a user input is received to select an image of an item of office equipment and to identify an operation to be performed by the office equipment on an electronic document. In step S12 the identified operation is performed on the electronic document and in step S13 the generated output for display is modified to display an image of the selected item of office equipment performing the selected function.

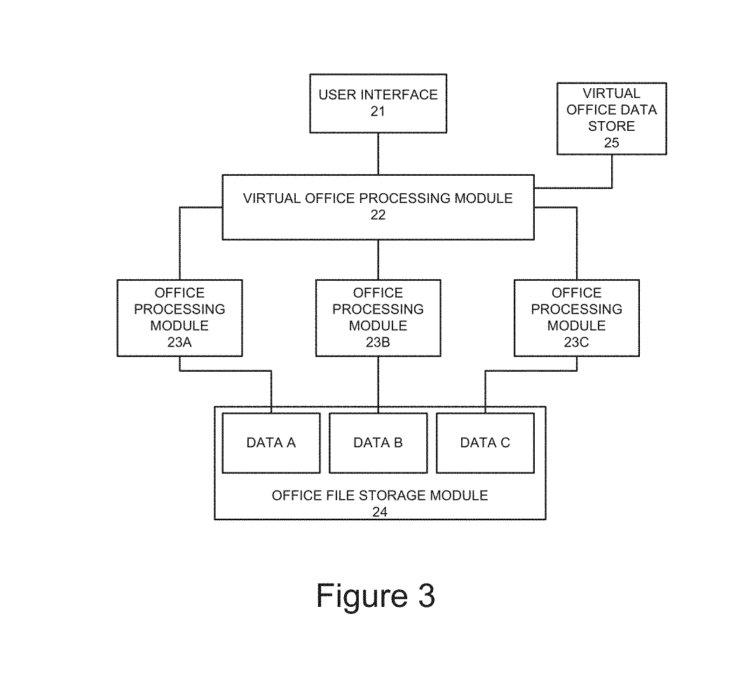

FIG. 3 is a schematic diagram illustrating an office system according to one embodiment.

In this embodiment, a virtual office processing module 22 is connected to a user interface 21 to provide a virtual office output for display using data stored in the virtual office data store 25. The virtual office processing module is interfaced to a plurality of office applications comprising office processing modules 23A, 23B and 23C. An office file storage module 24 is provided connected to each of the office processing modules 23A, 23B and 23C to store the data A, B and C respectively associated with respective office processing modules 23A, 23B and 23C. The office processing modules 23A, 23B and 23C can comprise any convention application for providing an office function, including high level applications for performing office functions such as word processing, presentation processing, spreadsheet processing, image processing, social networking, emailing, etc. and lower level application such as a printer driver, a shredder or secure delete application, etc. Thus in this embodiment, the virtual office environment provides a top level interface allowing a user to more intuitively perform office functions and access applications they are familiar with or that are standard and are required to be used in the office e.g. for policy reasons or for compatibility reasons.

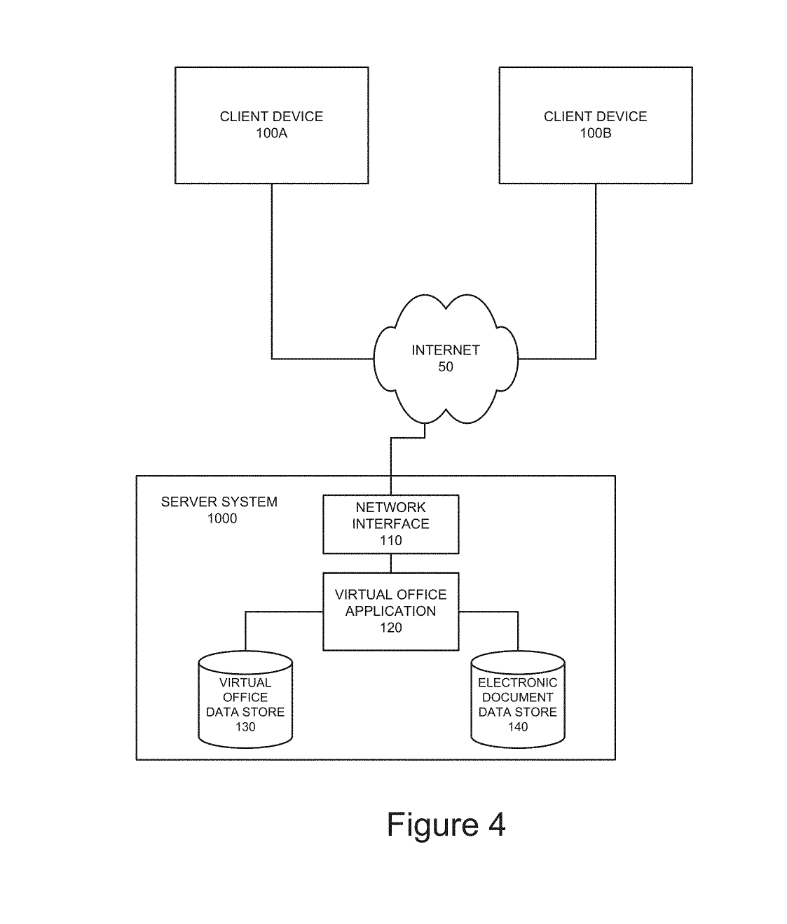

FIG. 4 is a schematic diagram illustrating a networked system providing a virtual office according to one embodiment.

FIG. 4 illustrates two client devices 100A and 100B, for use by a user. Any number of client devices may be used. The client devices 100A and 100B can comprise any type of computing or processing machine, such as a personal computer, a laptop, a tablet computer, a personal organizer, a mobile device, smart phone, a mobile telephone, a video player, a television, an audio player, a multimedia device, personal digital assistant, etc.

The client devices 100A and 100B are connected to a communications network, such as the internet 50. A server system 1000 is connected to the internet 50 to provide the virtual office over the internet 50. The server system 1000 comprises a network interface 110 and a virtual office application 120. The virtual office application is connected to a virtual office data store 130 that stores all of the required data to generate and render the virtual office environment for display at the client devices 100A and 100B. For example, the virtual office data store 130 may store image data for the items of office equipment, background office images, etc. A document data store 140 is connected to the virtual office application 120 to store the document data for use in the virtual office environment provided to the client devices 100A and 100B.

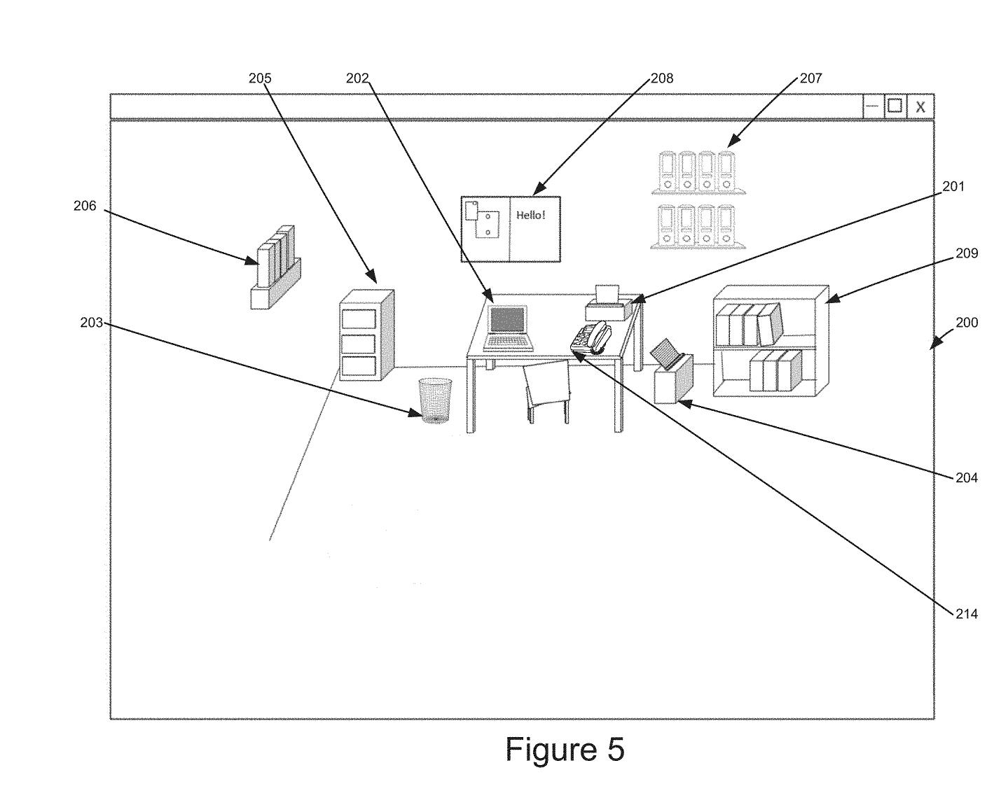

FIG. 5 is a schematic diagram illustrating a display of a virtual office output from the system according to one embodiment. The virtual office can be a representation of a 3D environment displayed on a 2D display.

The display 200 displays a virtual office including a desk, a chair and a number of items of office equipment that the user can interact with the input instructions for the processing of documents. In this embodiment on the desk is a laptop 202 and printer 201. By the desk is a trash basket 203 and a shredder 204 and in the corner is a filing cabinet 205. On one wall is a shelf with books 206 and on the other is a shelf with files 207 and a shared white board and pin board 208. A bookcase 209 is also displayed next to the desk. All of these displayed images of items of office equipment are selectable by a user to select to perform processing corresponding to the expected normal function of the illustrated item of office equipment. For example, if the user has a document open on the desk, they can place it by a drag and drop operation for example in the trash basket 203 to delete it. If the user wants to securely delete the document, they can place it, by a drag and drop operation for example, in the shredder 204. To print a document, a user can drag a drop the document onto the printer 201 to cause the printing operation. Although drag and drop operations are described as examples, the user can interface by any means such as touch and voice.

The shared whiteboard and pin board 208 enables the user to write messages and add documents to be viewable by other users that can use the shared office environment.

The bookcase 209 enables a user to select it to access a library of reference books. An image of a telephone 214 is provided to enable a user to select the image to initiate the office function of a telephone call (or a video call if the telephone has a video function).

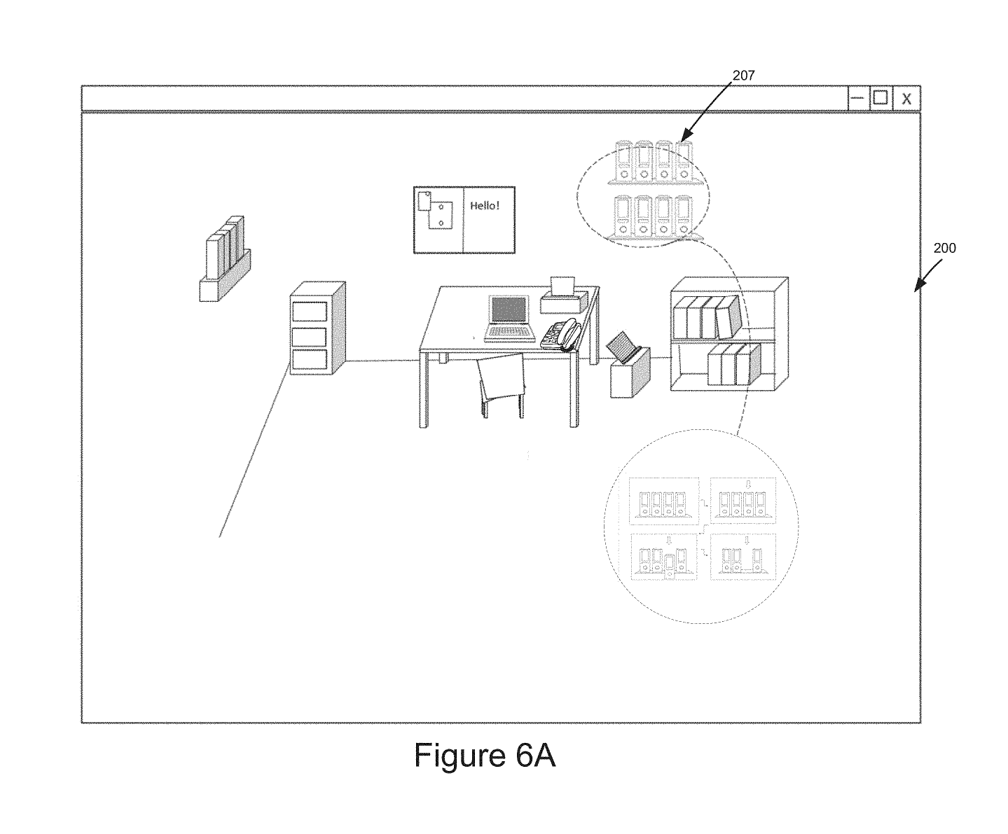

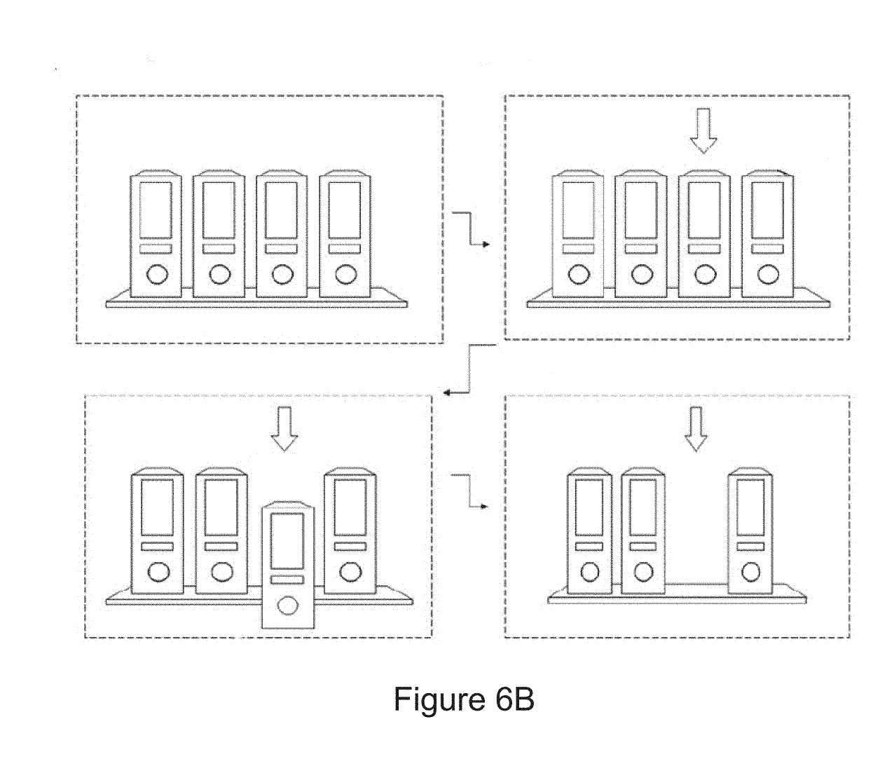

The execution of other office functions using the virtual office environment will now be described with reference to FIGS. 6 to 14.

FIGS. 6A and 6B are schematic diagrams illustrating a display of a virtual office output from the system during file selection according to one embodiment.

As shown in FIG. 6A, a user can select the files 207 on the shelf to search for an open a document in one of the files. The sequence of images that appear in the virtual office are illustrated in FIG. 6B, which illustrated the animated states of the files 207 on the shelf during the process. When a user makes a selection of a file is is shown as moving from the shelf to leave an empty space on the shelf.

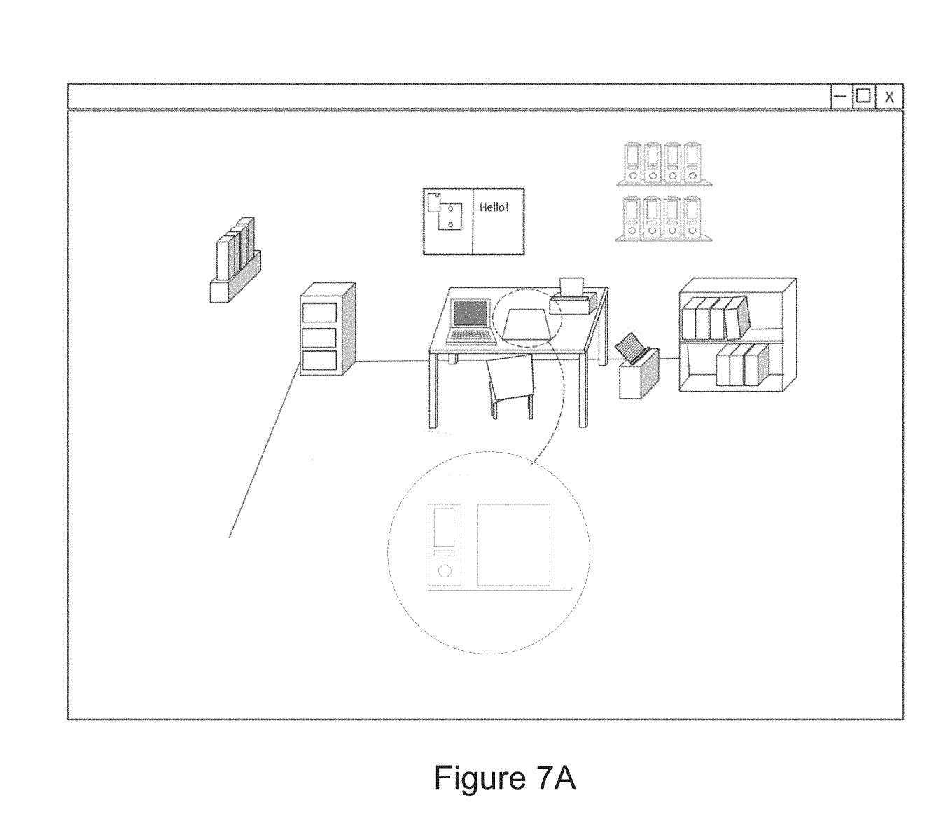

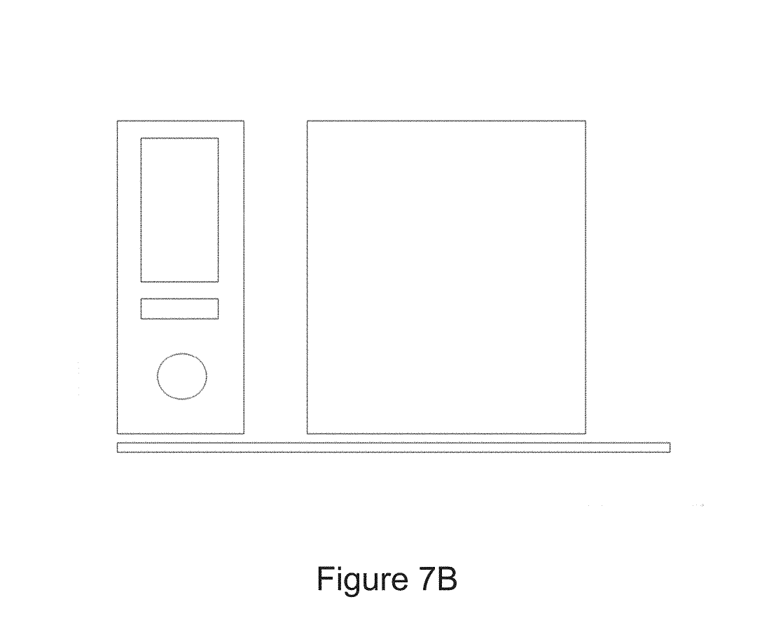

FIGS. 7A and 7B are schematic diagrams illustrating a display of a virtual office output from the system during document selection according to one embodiment.

When the file is selected in FIG. 6B, it is placed on the desk and a user can select a document from the file. The selected document is shown open on the desk next to the selected file. To read the document, the user can select it and it will be displayed in a larger form. If the user wishes to operate on the document, the user can select to manipulate the document, e.g. edit it, and a word processing application can be opened to enable the word processing of the document. The word processing interface can overlay the virtual office display or in a separate display area or separate display screen. This applies equally to access any other document processing application, such as a spreadsheet application, presentation application, or accounts application etc.

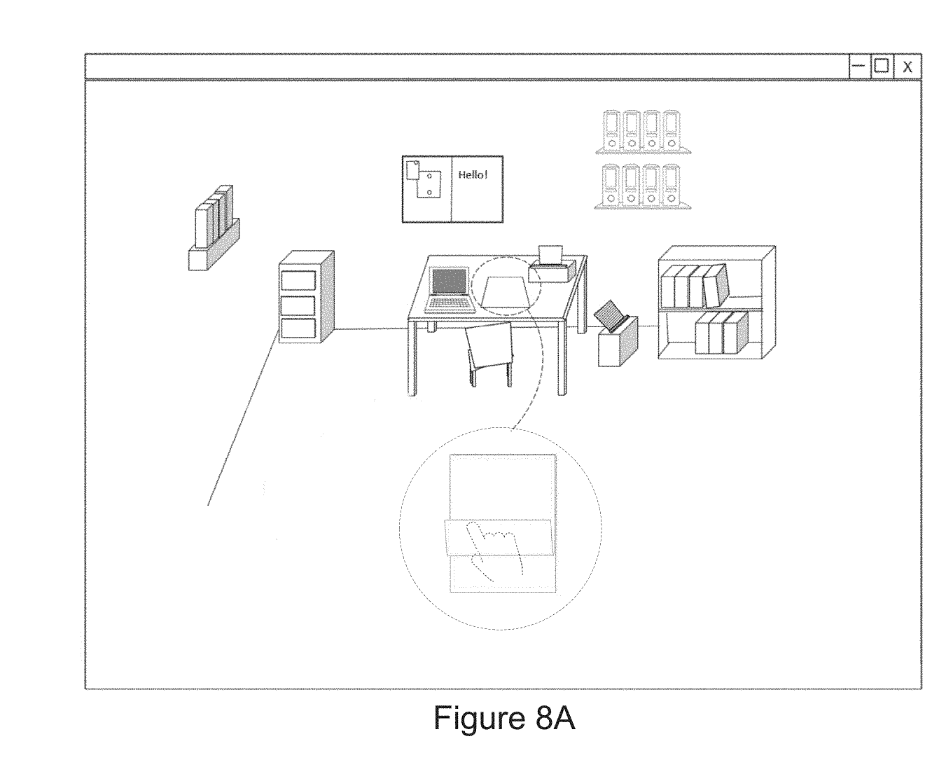

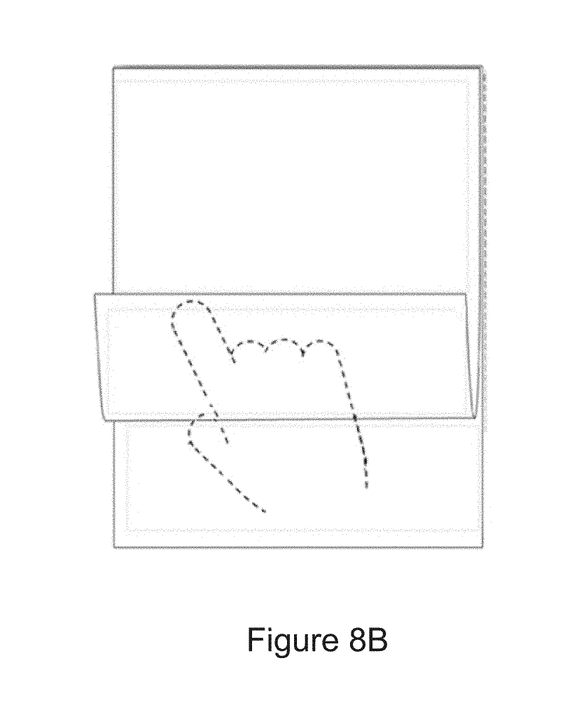

The display of the document in a display area can be manipulated in a similar manner that a user would interact with paper. FIGS. 8A and 8B are schematic diagrams illustrating a display of a virtual office output from the system during page turning of a document according to one embodiment. Hence, the user is able to select to display a next page by performing a simple selection operation such as a drag operation to turn a page of the document and the image of the paper (an item of office equipment) is modified to illustrate the page turning operation.

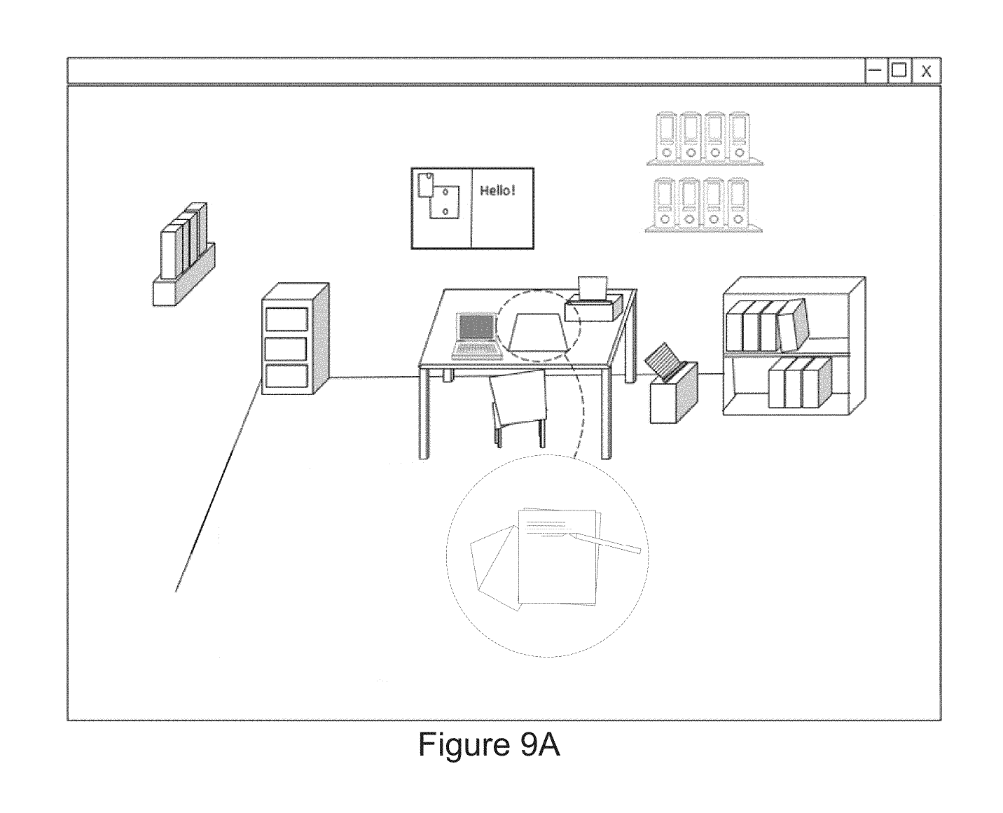

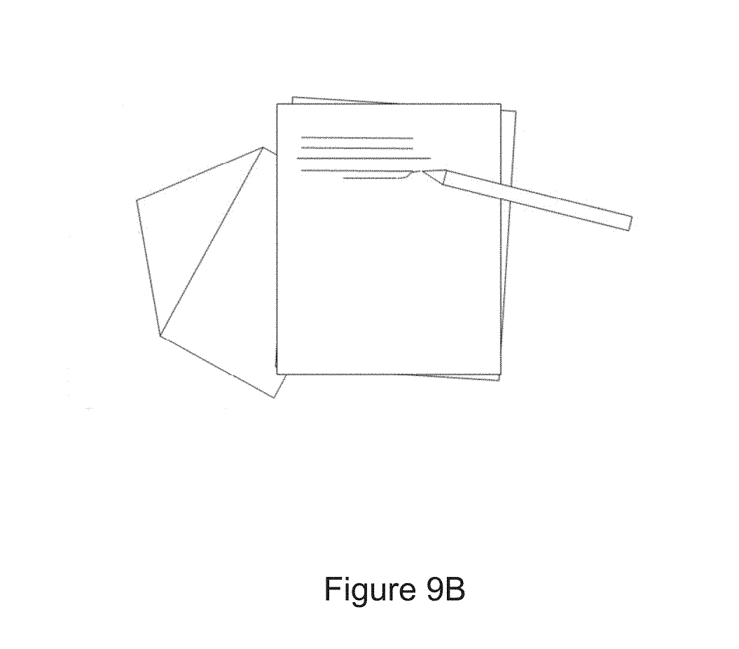

FIGS. 9A and 9B are schematic diagrams illustrating a display of a virtual office output from the system during writing of a document according to one embodiment

In this embodiment, the interaction of the user with the document can be displayed on the table and the user input can be displayed as an action of a pen writing on the paper.

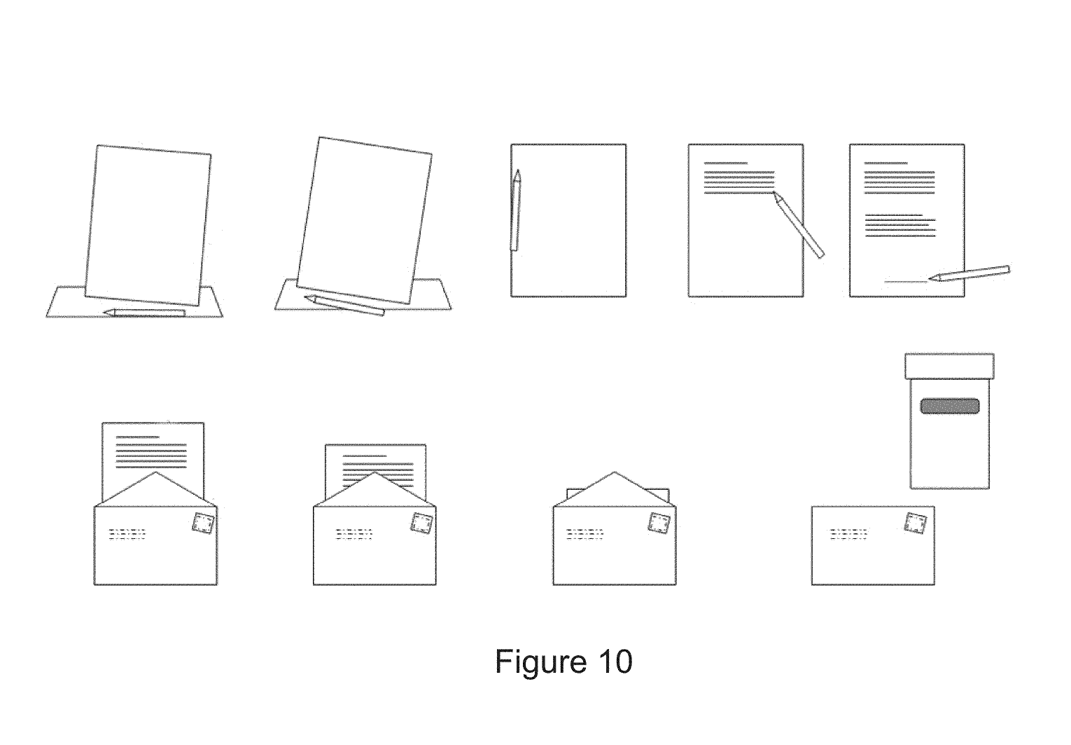

FIG. 10 is a diagram illustrating a display sequence output from the system during document virtual posting according to one embodiment.

In this embodiment, the document can be displayed on the table and a user can select to write a document and send it as an electronic communication, such as an email. The sequence of FIG. 10 illustrates the operation selecting a document, writing on the document, inserting the document into a virtual envelope, addressing the envelope, and posting the envelope. A stamp can be affixed to the envelope and in order to acquire a stamp a user may be required to pay or obtain permission. The stamp can include any desired image, such as the company logo.

The virtual office represents different type of office environment whereby dealing with virtual mail is an important operation in the office. The virtual mail posting and delivery system allows for the sending and receiving i.e. posting and delivery of the virtual mail including virtual correspondence; including virtual, letters, leaflets, cards flyers, parcels etc.

This embodiment provides a visual and intuitive method for a user to send electronic communications, such as email.

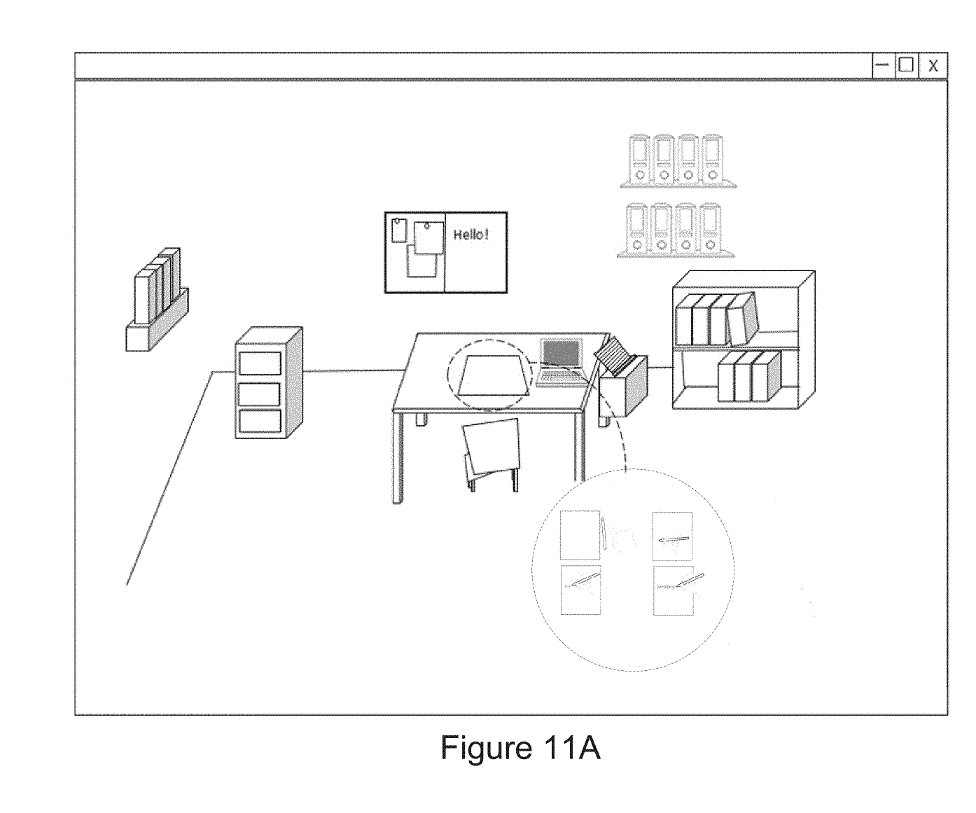

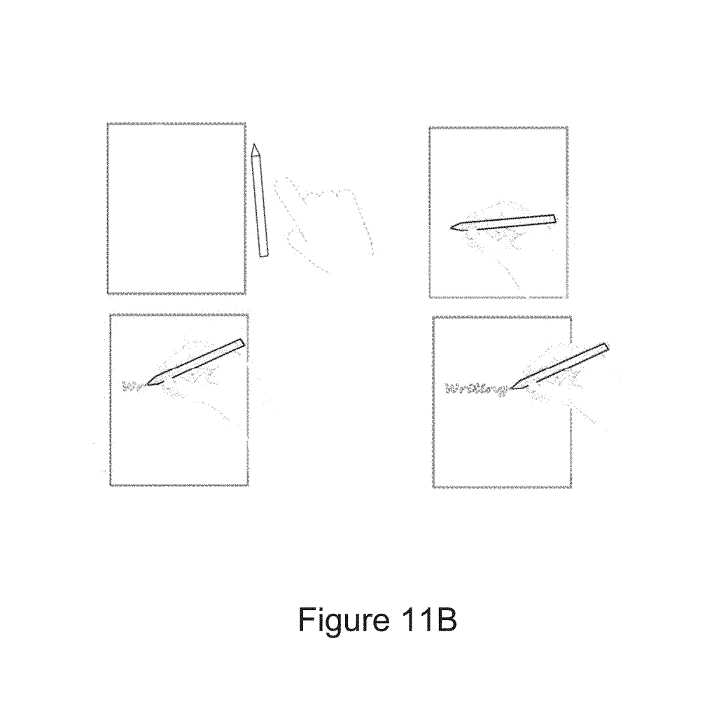

FIGS. 11A and 11B are schematic diagrams illustrating a display of a virtual office output from the system during document writing according to one embodiment. In this embodiment, a user can write noted on a notepad and these can be stored as a document. The writing operation can be illustrated as a virtual writing instrument such as a pen or pencil writing onto virtual paper.

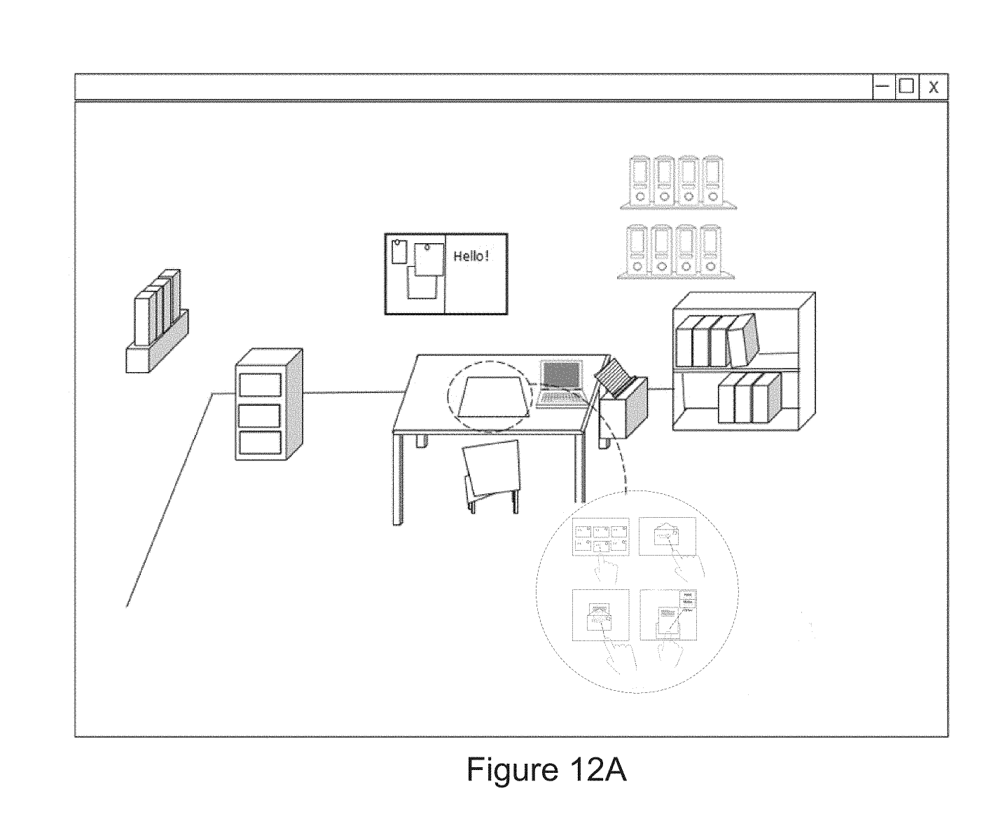

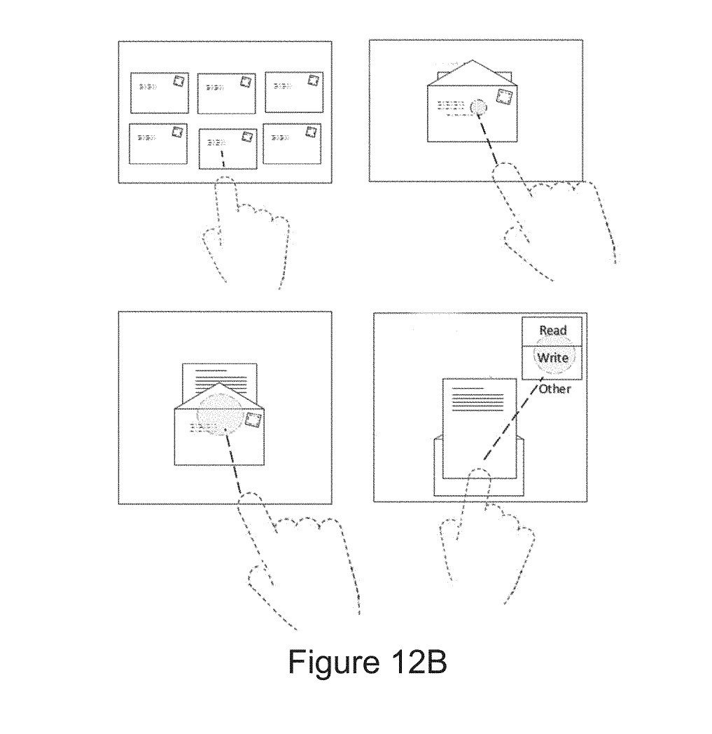

FIGS. 12A and 12B are schematic diagrams illustrating a display of a virtual office output from the system during mail reading according to one embodiment. Thus embodiment can be used in conjunction with the embodiment of FIG. 10, which describe the creation and sending of electronic communications.

A user may be notified that they have mail (or any form of electronic communications) by a simple notification. In one embodiment the notification could be a pile of virtual envelopes on the desk or in an in-tray. The user can select to view the envelopes as shown in the first part of FIG. 12B and a user can select to open one of the envelopes and read the document contain therein. The user can also select to reply to the message in the envelope and the envelope can automatically readdress to send back to the sender.

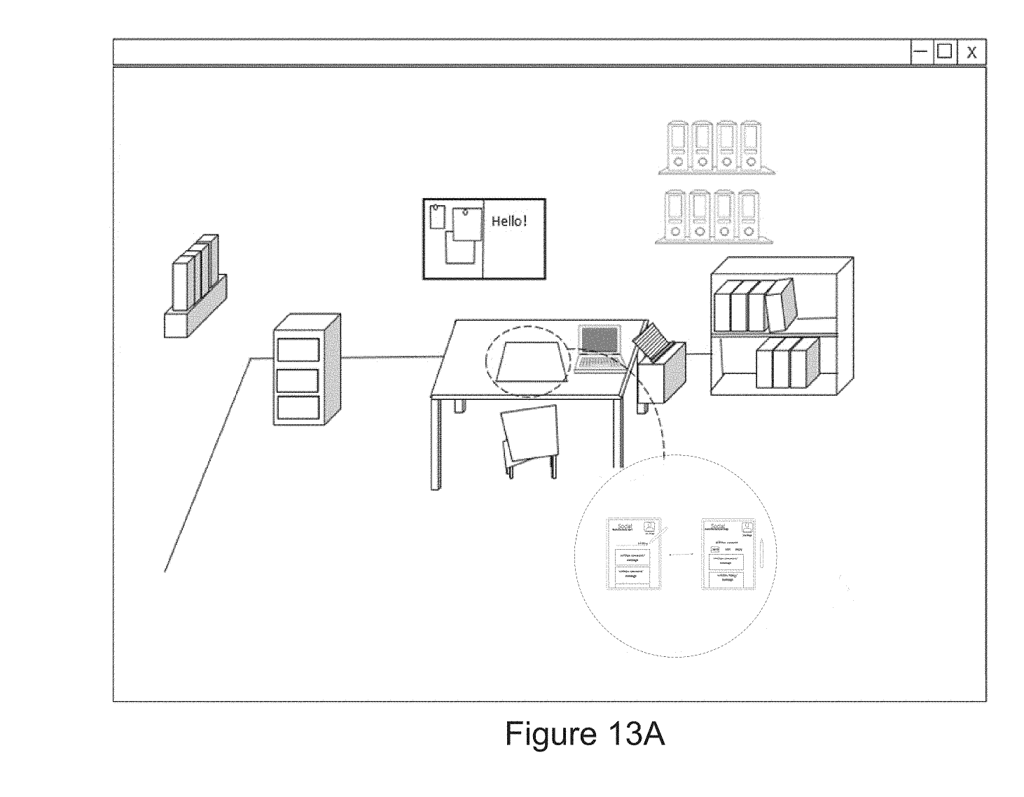

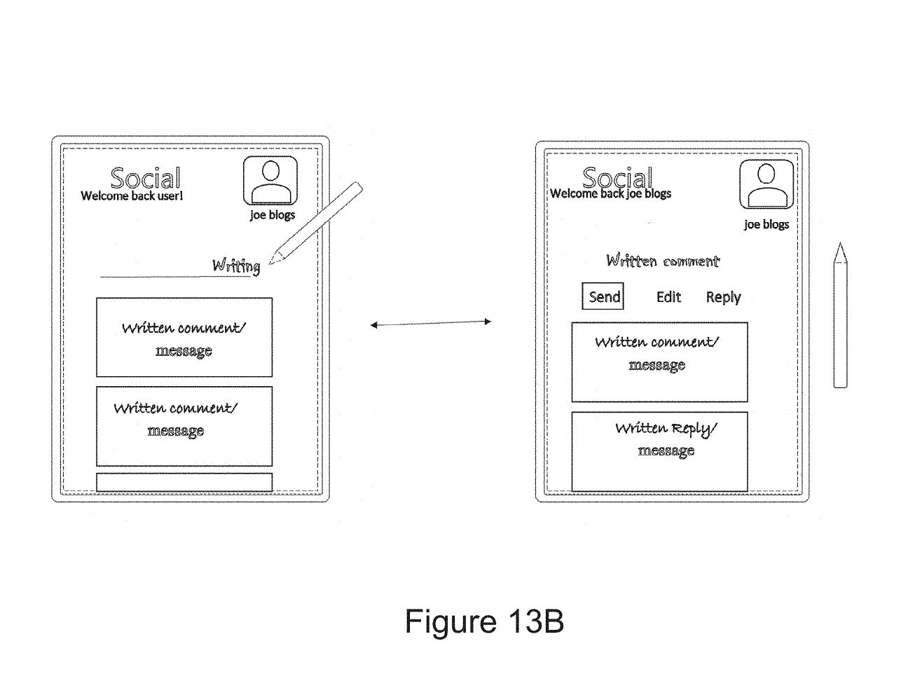

FIGS. 13A and 13B are schematic diagrams illustrating a display of a virtual office output from the system during social network entry according to one embodiment.

A document in this embodiment comprises text entered into a social network interface. The user is able to open a social network page as a document and to interact with it as if it were document.

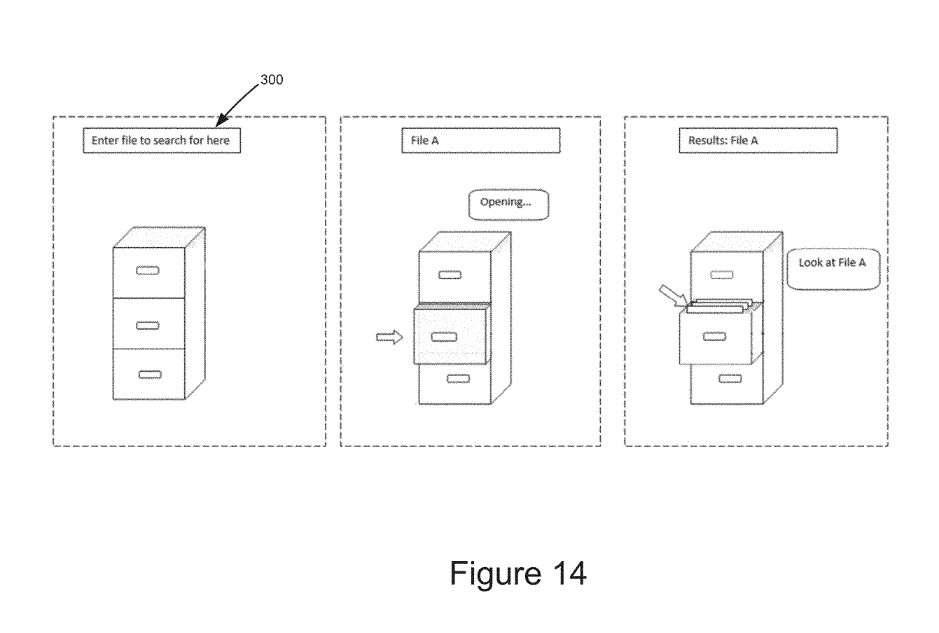

FIG. 14 is a schematic diagram illustrating display in a section of a virtual office output from the system during document filing and searching according to one embodiment. This embodiment illustrates the interaction by a user with the filing cabinet 205 of FIG. 5.

When a user selects the filing cabinet 205, a search entry box 300 can be displayed to enable a user to enter a search string as a query for a document stored in the filing cabinet. When a user enters the query “File A” and the file is found, the filing cabinet image is modified to show a drawer opening and a document being taken out.

The virtual office can also be a home office. The virtual office interface can also be used as an interface to a virtual office that can be ‘occupied’ or shared with multiple users and is a shared office environment whereby an administrator user can be, for example, the employer. There may be many offices within the main virtual office area, or they can be linked in with each other. In this environment files may be accessed, transferred and shared. Similarly, users can share books using the bookshelf, view each other's books, add books to the bookshelf, and download new books from a source, such as over the internet.

Although the virtual office has been described above with no reference to the depiction of any office workers, in an embodiment, office workers can be depicted by avatars. The avatars can interact and the virtual office displayed can encompass a virtual meeting or conference to enable the attendees to interact with images of items of office equipment. The avatars can interact with each other and they can interact with the virtual office equipment to move the images of the office equipment in the virtual office to reconfigure the layout of the office.

In one embodiment, the method and system can be used with the method and apparatus disclosed in copending US patent application number, filed on the same date as this application and entitled “VIRTUAL MEETING PARTICIPANT RESPONSE INDICATION METHOD AND SYSTEM”, the content of which is hereby incorporated in its entirety.

The user can, in one embodiment, interface with a displayed output and use a pointer device and keyboard to make the user inputs. In alternative embodiments, the user interface can be any form of visual output and any form of input such as keyboard, touch screen, pointer device (such as a mouse, trackball, trackpad, or pen device), audio recognition hardware and/or software to recognize a sounds or speech from a user, gesture recognition input hardware and/or software, etc.

### Basic Computing Device

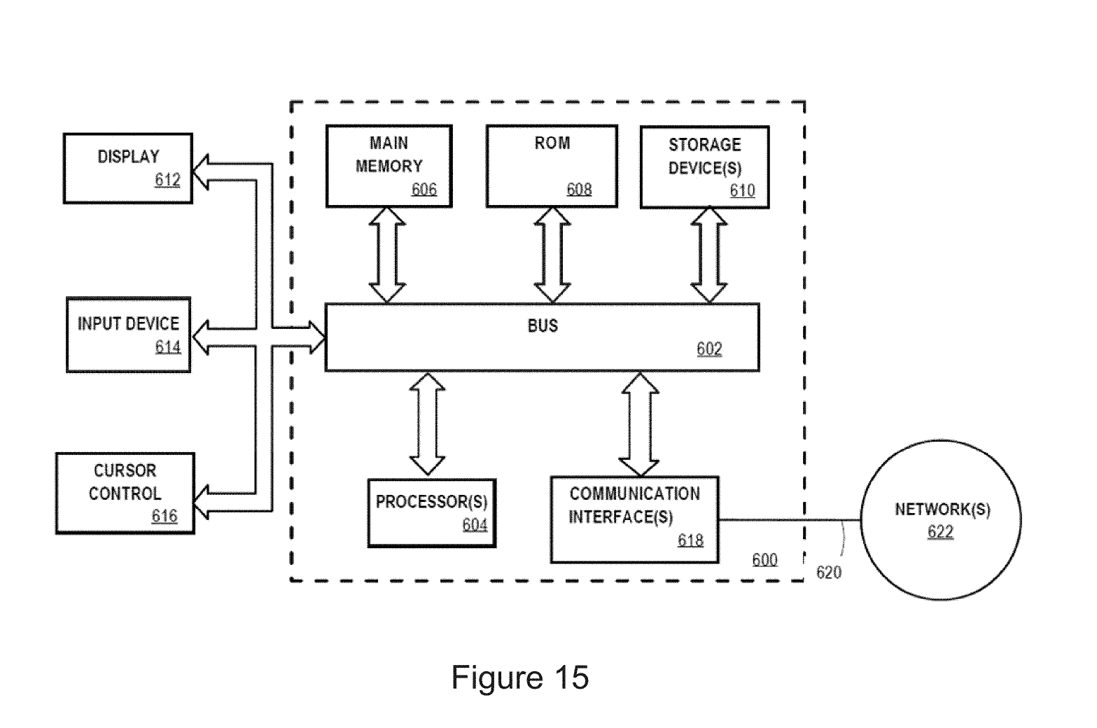

FIG. 15 is a block diagram that illustrates a basic computing device 600 in which the example embodiment(s) of the present invention may be embodied. Computing device 600 and its components, including their connections, relationships, and functions, is meant to be exemplary only, and not meant to limit implementations of the example embodiment(s). Other computing devices suitable for implementing the example embodiment(s) may have different components, including components with different connections, relationships, and functions.

The computing device 600 can comprise any of the servers or the client device as illustrated in FIG. 3 or the computer apparatus on which the modules of FIG. 1 are implemented for example.

Computing device 600 may include a bus 602 or other communication mechanism for addressing main memory 606 and for transferring data between and among the various components of device 600.

Computing device 600 may also include one or more hardware processors 604 coupled with bus 602 for processing information. A hardware processor 604 may be a general purpose microprocessor, a system on a chip (SoC), or other processor.

Main memory 606, such as a random access memory (RAM) or other dynamic storage device, also may be coupled to bus 602 for storing information and software instructions to be executed by processor(s) 604. Main memory 606 also may be used for storing temporary variables or other intermediate information during execution of software instructions to be executed by processor(s) 604.

Software instructions, when stored in storage media accessible to processor(s) 604, render computing device 600 into a special-purpose computing device that is customized to perform the operations specified in the software instructions. The terms “software”, “software instructions”, “computer program”, “computer-executable instructions”, and “processor-executable instructions” are to be broadly construed to cover any machine-readable information, whether or not human-readable, for instructing a computing device to perform specific operations, and including, but not limited to, application software, desktop applications, scripts, binaries, operating systems, device drivers, boot loaders, shells, utilities, system software, JAVASCRIPT, web pages, web applications, plugins, embedded software, microcode, compilers, debuggers, interpreters, virtual machines, linkers, and text editors.

Computing device 600 also may include read only memory (ROM) 608 or other static storage device coupled to bus 602 for storing static information and software instructions for processor(s) 604.

One or more mass storage devices 610 may be coupled to bus 602 for persistently storing information and software instructions on fixed or removable media, such as magnetic, optical, solid-state, magnetic-optical, flash memory, or any other available mass storage technology. The mass storage may be shared on a network, or it may be dedicated mass storage. Typically, at least one of the mass storage devices 610 (e.g., the main hard disk for the device) stores a body of program and data for directing operation of the computing device, including an operating system, user application programs, driver and other support files, as well as other data files of all sorts.

Computing device 600 may be coupled via bus 602 to display 612, such as a liquid crystal display (LCD) or other electronic visual display, for displaying information to a computer user. In some configurations, a touch sensitive surface incorporating touch detection technology (e.g., resistive, capacitive, etc.) may be overlaid on display 612 to form a touch sensitive display for communicating touch gesture (e.g., finger or stylus) input to processor(s) 604.

An input device 614, including alphanumeric and other keys, may be coupled to bus 602 for communicating information and command selections to processor 604. In addition to or instead of alphanumeric and other keys, input device 614 may include one or more physical buttons or switches such as, for example, a power (on/off) button, a “home” button, volume control buttons, or the like.

Another type of user input device may be a cursor control 616, such as a mouse, a trackball, a cursor, a touch screen, or direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. Other input device embodiments include an audio or speech recognition input module to recognize audio input such as speech, a visual input device capable of recognizing gestures by a user, and a keyboard.

While in some configurations, such as the configuration depicted in FIG. 15, one or more of display 612, input device 614, and cursor control 616 are external components (i.e., peripheral devices) of computing device 600, some or all of display 612, input device 614, and cursor control 616 are integrated as part of the form factor of computing device 600 in other configurations.

In addition to or in place of the display 612 any other form of user output device can be sued such as an audio output device or a tactile (vibrational) output device.

Functions of the disclosed systems, methods, and modules may be performed by computing device 600 in response to processor(s) 604 executing one or more programs of software instructions contained in main memory 606. Such software instructions may be read into main memory 606 from another storage medium, such as storage device(s) 610 or a transmission medium. Execution of the software instructions contained in main memory 606 cause processor(s) 604 to perform the functions of the example embodiment(s).

While functions and operations of the example embodiment(s) may be implemented entirely with software instructions, hard-wired or programmable circuitry of computing device 600 (e.g., an ASIC, a FPGA, or the like) may be used in other embodiments in place of or in combination with software instructions to perform the functions, according to the requirements of the particular implementation at hand.

The term “storage media” as used herein refers to any non-transitory media that store data and/or software instructions that cause a computing device to operate in a specific fashion. Such storage media may comprise non-volatile media and/or volatile media. Non-volatile media includes, for example, non-volatile random access memory (NVRAM), flash memory, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications. A machine readable medium carrying instructions in the form of code can comprise a non-transient storage medium and a transmission medium.

Various forms of media may be involved in carrying one or more sequences of one or more software instructions to processor(s) 604 for execution. For example, the software instructions may initially be carried on a magnetic disk or solid-state drive of a remote computer. The remote computer can load the software instructions into its dynamic memory and send the software instructions over a telephone line using a modem. A modem local to computing device 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor(s) 604 retrieves and executes the software instructions. The software instructions received by main memory 606 may optionally be stored on storage device(s) 610 either before or after execution by processor(s) 604.

Computing device 600 also may include one or more communication interface(s) 618 coupled to bus 602. A communication interface 618 provides a two-way data communication coupling to a wired or wireless network link 620 that is connected to a local network 622 (e.g., Ethernet network, Wireless Local Area Network, cellular phone network, Bluetooth wireless network, or the like). Communication interface 618 sends and receives electrical, electromagnetic, or optical signals that carry digital data streams representing various types of information. For example, communication interface 618 may be a wired network interface card, a wireless network interface card with an integrated radio antenna, or a modem (e.g., ISDN, DSL, or cable modem).

Network link(s) 620 typically provide data communication through one or more networks to other data devices. For example, a network link 620 may provide a connection through a local network 622 to a host computer or to data equipment operated by an Internet Service Provider (ISP). ISP in turn provides data communication services through the world wide packet data communication network now commonly referred to as the “Internet”. Local network(s) 622 and Internet use electrical, electromagnetic or optical signals that carry digital data streams. The signals through the various networks and the signals on network link(s) 620 and through communication interface(s) 618, which carry the digital data to and from computing device 600, are example forms of transmission media.

Computing device 600 can send messages and receive data, including program code, through the network(s), network link(s) 620 and communication interface(s) 618. In the Internet example, a server might transmit a requested code for an application program through Internet, ISP, local network(s) 622 and communication interface(s) 618.

The received code may be executed by processor 604 as it is received, and/or stored in storage device 610, or other non-volatile storage for later execution.

One aspect provides a carrier medium, such as a non-transient storage medium storing code for execution by a processor of a machine to carry out the method, or a transient medium carrying processor executable code for execution by a processor of a machine to carry out the method. Embodiments can be implemented in programmable digital logic that implements computer code. The code can be supplied to the programmable logic, such as a processor or microprocessor, on a carrier medium. One such embodiment of a carrier medium is a transient medium i.e. a signal such as an electrical, electromagnetic, acoustic, magnetic, or optical signal. Another form of carrier medium is a non-transitory storage medium that stores the code, such as a solid-state memory, magnetic media (hard disk drive), or optical media (Compact disc (CD) or digital versatile disc (DVD)).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method of providing a virtual office, the method comprising:
generating an output for display of a virtual office including a plurality of images of items of office equipment arranged in the virtual office, each item of office equipment having stored image data for use in the generation of the image in the virtual office and code to perform an associated office function;
receiving a user input to select an image of an item of office equipment and to identify an operation to be performed by the office equipment;
performing the identified operation; and
modifying the generated output for display to display an image of the selected item of office equipment performing the selected function.

2. A method according to claim 1, wherein at least one office function comprises an operation on an electronic document.

3. A method according to claim 1, wherein generated output is modified to display an animation of the image of the selected item performing the selected function.

4. A method according to claim 1, wherein the office equipment comprises paper carrying the electronic document content and the identified operation comprises turning a page, and the generated output is modified to display the image of the paper and electronic document content with a page turning.

5. A method according to claim 1, wherein the office equipment comprises paper carrying the electronic document content and a writing instrument, and the identified operation comprises writing on the paper, the generated output is modified to display the image of the writing appearing on the paper, and the electronic document is modified according to the writing.

6. A method according to claim 5, wherein the office equipment includes an envelope and the identified operation comprises writing on the envelope, inserting the paper in the envelope and posting the envelope, the generated output is modified to display the image of the paper being inserted into the envelope, the image of the writing appearing on the envelope, and the image of the envelope being inserted into a postbox, and the identified operation comprises electronically communicating the electronic document in accordance with the writing on the envelope.

7. A method according to claim 1, wherein the office equipment comprises files containing documents, the electronic documents are stored in electronic files associated with images of the files, the identified operation comprises selecting a file, and the generated output is modified to display an image of the file being selected.

8. A method according to claim 7, wherein the identified operation comprises opening a file, and the generated output is modified to display an image of the file being opened.

9. A method according to claim 8, wherein the identified operation comprises selecting a document in the file, and the generated output is modified to display an image of the document being opened.

10. A method according to claim 1, wherein the office equipment include a telephone or videophone and the associated operation stored for the office function for the telephone is to a make a voice or video telephone call.

11. A method according to claim 1, wherein the output for display of the virtual office is generated using a virtual office application, the at least one of the office functions is implemented using an office application, and the virtual office application is interfaced to the at least one office application.

12. A system to provide a virtual office comprising:
at least one processor; and
a memory storing instructions, which instructions being executable by the at least one processor to:
generate an output for display of a virtual office including a plurality of images of items of office equipment arranged in the virtual office, each item of office equipment having stored image data for use in the generation of the image in the virtual office and code to perform an associated office function;
receive a user input to select an image of an item of office equipment and to identify an operation to be performed by the office equipment;
perform the identified operation; and
modify the generated output for display to display an image of the selected item of office equipment performing the selected function.

13. A system according to claim 12, wherein at least one office function comprises an operation on an electronic document.

14. A system according to claim 12, wherein generated output is modified to display an animation of the image of the selected item performing the selected function.

15. A system according to claim 12, wherein the office equipment comprises paper carrying the electronic document content and the identified operation comprises turning a page, and the generated output is modified to display the image of the paper and electronic document content with a page turning.

16. A system according to claim 12, wherein the office equipment comprises paper carrying the electronic document content and a writing instrument, and the identified operation comprises writing on the paper, the generated output is modified to display the image of the writing appearing on the paper, and the electronic document is modified according to the writing.

17. A system according to claim 16, wherein the office equipment includes an envelope and the identified operation comprises writing on the envelope, inserting the paper in the envelope and posting the envelope, the generated output is modified to display the image of the paper being inserted into the envelope, the image of the writing appearing on the envelope, and the image of the envelope being inserted into a postbox, and the identified operation comprises electronically communicating the electronic document in accordance with the writing on the envelope.

18. A system according to claim 12, wherein the office equipment comprises files containing documents, the electronic documents are stored in electronic files associated with images of the files, the identified operation comprises selecting a file, and the generated output is modified to display an image of the file being selected.

19. A system according to claim 18, wherein the identified operation comprises opening a file, and the generated output is modified to display an image of the file being opened.

20. A system according to claim 19, wherein the identified operation comprises selecting a document in the file, and the generated output is modified to display an image of the document being opened.

21. A system according to claim 12, wherein the office equipment include a telephone or videophone and the associated operation stored for the office function for the telephone is a make a voice or video telephone call.

22. A system according to claim 12, wherein the instructions comprise a virtual office application to generate the output for display of the virtual office, wherein the virtual office application is interfaced to at least one office application for performing the office functions.

23. A non-transient storage medium storing processor executable code for execution by a processor to:
generate an output for display of a virtual office including a plurality of images of items of office equipment arranged in the virtual office, each item of office equipment having stored image data for use in the generation of the image in the virtual office and code to perform an associated office function;
receive a user input to select an image of an item of office equipment and to identify an operation to be performed by the office equipment;
perform the identified operation; and
modify the generated output for display to display an image of the selected item of office equipment performing the selected function.
